(19) United States
(12) Patent Application Publication
(10) Pub. No.: US 2015/0356212 A1
(43) Pub. Date: Dec. 10, 2015

(54) SENIOR ASSISTED LIVING METHOD AND SYSTEM

(71) Applicant: J. CRAIG OXFORD, NASHVILLE, TN (US)

(72) Inventor: J. CRAIG OXFORD, NASHVILLE, TN (US)

(21) Appl. No.: 14/679,681

(22) Filed: Apr. 6, 2015

Related U.S. Application Data
(60) Provisional application No. 61/975,019, filed on Apr. 4, 2014.
(60) Provisional application No. 62/029,630, filed on Jul. 28, 2014.

(51) Int. Cl. G06F 17/50

(52) U.S. Cl. CPC G06F 17/5004

(57) ABSTRACT

A system for analyzing, modeling and improving the “acoustic wellness” of various public and private spaces, particularly in assisted-living communities or facilities. The system may be implemented by the steps of selecting an area within a facility, acoustically mapping the area, modeling acoustics at each listener location in the area, developing acoustic remediation solutions for the area, and implementing the acoustic remediation solutions.

This application claims benefit of and priority to U.S. Provisional Application No. 61/975,019, filed Apr. 4, 2014, by J. Craig Oxford, and U.S. Provisional Application No. 62/029,630, filed Jul. 28, 2014, and is entitled to those filing dates for priority in whole or in part. The specifications, figures and complete disclosures of U.S. Provisional Application Nos. 61/975,019 and 62/029,630 are incorporated herein by specific reference for all purposes.

### FIELD OF INVENTION

This invention relates to a system and method for promoting acoustic wellness in living communities, particularly senior living communities.

### SUMMARY OF INVENTION

In various exemplary embodiments, the present system is designed to improve the “acoustic wellness” of various public and private spaces, particularly in assisted-living communities or facilities, although the techniques and processes described below can be used in other areas or facilities, such as facilities or locations providing hospice care, hospice centers, nursing homes, hospitals, and residences. The techniques and process described below may also be used in auditoriums, conference centers, meeting halls, convention centers, hotel meeting rooms, and other locations.

In one exemplary embodiment, the present invention comprises an acoustic assessment 100 of the common or public areas in the assisted-living community or facility. These areas are selected area-by-area 200, and include, but are not limited to, dining rooms, theatres, game rooms, and activity or multi-purpose rooms where lectures, sermons, presentations, movies, meetings, entertainment, performances and the like are conducted for individuals or groups. The entire space thus is acoustically mapped 300, with measurements of reverb time and noise level with different weightings at each table or listener location within the space. The process also measures HVAC noise, particularly white noise and air handler rumble. These measurements are done with senior-specific methods, practices and priorities. Ordinary, conventional acoustic measurements are not optimized for the hard of hearing, with or without hearing aids, or those with dementia.

A computer program models 400 the acoustics at each table or listener location in the space, and identifies speech intelligibility/reverb/decay/amplitude with and without occupants. The program then develops acoustic remediation solutions 500. These include, but are not limited to, modifications to the HVAC system to reduce white noise and air handler rumble, including modifications to mounts, ductwork baffles and air velocity. Remediation solutions also include sound-absorbing panels engineered to reduce white noise, which are then built and installed where necessary. This process can be completed for one area or multiple areas.

In yet another embodiment, the present invention comprises an assessment of sound reinforcement of lectures, presentations, parties, meetings, and the like. The loss of hearing in one or both ears, especially when compounded by Alzheimer's disease or dementia, diminishes or destroys the “Cocktail Party Effect” (i.e., the ability of a person to discern what another is saying when multiple people are speaking at once), which is essential for conversation in group or crowded settings. Special signal processing and electro-acoustic modifications are used to promote limbic engagement, such as broad dispersion loudspeakers where the dispersion is not modulated by frequency and the amplitude is not modulated by the impedance.

In several embodiments, broad dispersion loudspeakers are spaced so that there are no gaps in coverage, particularly in the vocal range between 300 and 4000 Hz. Conventional wisdom includes a midrange that when measured on axis crosses over to a tweeter between 2000 and 2500 Hz. However, any non-linearity in dispersion and amplitude between 300 and 4000 Hz at any seating position is sub-optimal for the hearing impaired, with or without hearing aids, and for anyone with dementia. These individuals simply cannot discern the voice they are trying to listen to from the background noise, revert, and sounds of others speaking.

In one embodiment, the system uses ceiling speakers with the above characteristics and placement. In another embodiment, the broad dispersion speakers are wall mounted (e.g., a HEAL line array). Every area with a listener is illuminated with all frequencies.

In one embodiments, the speakers comprise Model 15 Reference PipeDreams Line Arrays with 4-inch midrange speakers and 1-inch tweeters. The mid-range speakers handle 125-3500 Hz with no crossover in that range. This design is optimum for a wide room with a low ceiling. Closely-spaced ceiling speakers may be used in rooms with higher ceilings. All installations attach to video, and also may comprise hearing aid loops (as described below).

In yet another embodiment, the present invention comprises one or more hearing aid loops in one or more of the spaces described above (e.g., activity or multi-purpose meeting rooms). These loops comprise an inductively-coupled antenna that broadcasts directly to a “T” coil in modern hearing aids (i.e., without sound waves travelling through the air). Senior-specific signal processing is used to enhance intelligibility and the emotional appreciation of music and sounds. In one embodiment, the signal processing incorporates equalization and a euphonic harmonic circuit. The harmonic enhancement assists those with hearing loss to feel sound and music and “fill in the blanks” in their hearing.

The cochlea is populated with small hairs or cilia, which transmit sound vibrations to nerves that are arrayed along its length and curve. With hearing loss there is usually organic death or disability of these hairs and follicles along portions of the cochlea. Some frequencies are detectable and others are lost or seriously attenuated. By adding and transmitting certain harmonics corresponding to octave jumps in modern music to fundamental frequencies, the ear and brain is able to extrapolate or synthesize missing parts of sounds by sum and difference psychoacoustics. Intelligibility is enhanced, music is more enjoyable, and importantly, the opportunity for limbic (startle) response is enabled. Enhancing or restoring intelligibility is critical to diminishing isolation and loneliness. The present invention restores serum dopamine elevation capability through sound and music and hearing with live or recorded music, and is novel to an ageing population that has lost this experience. While particularly useful to ageing populations, especially in conjunction with cognitive associations, the methods are not limited to those populations.

In yet another embodiment, the system provides senior-specific licensed music content. In one embodiment, this music is selected to avoid references to unhappiness, ageing, and similar topics. Instrumental music is played at meal times so the Cocktail Party Effect is not exacerbated by words in vocal music content.

In yet a further embodiment, acoustic absorbing panels may be installed in individual resident's rooms, with or without loop antennas concealed inside. A small, rechargeable portable loop amplifier with microphone may also be provided to individuals, which can be used at dining room tables, similar areas, or in private rooms. For example, when used in a private room, an internal or external microphone can be used for communication with staff, family or friends. A digital or analog input can provide connection to TV, computer, Wi-Fi, Airplay, or the like.

In one embodiment, the acoustic panels may be printed with fabric that color coordinates with wall colors or room décor, or may be printed with photographs, art, scenes, or other images. They can be configured as tiles. In one example, multiple panels can appear as a view of a beach or mountain landscape from a large window. In another embodiment, the panels may be video panels or a video wall with similar imagery.

### BRIEF DESCRIPTION OF THE DRAWINGS

FIG. 1 shows a view of a system in accordance with an embodiment of the present invention.

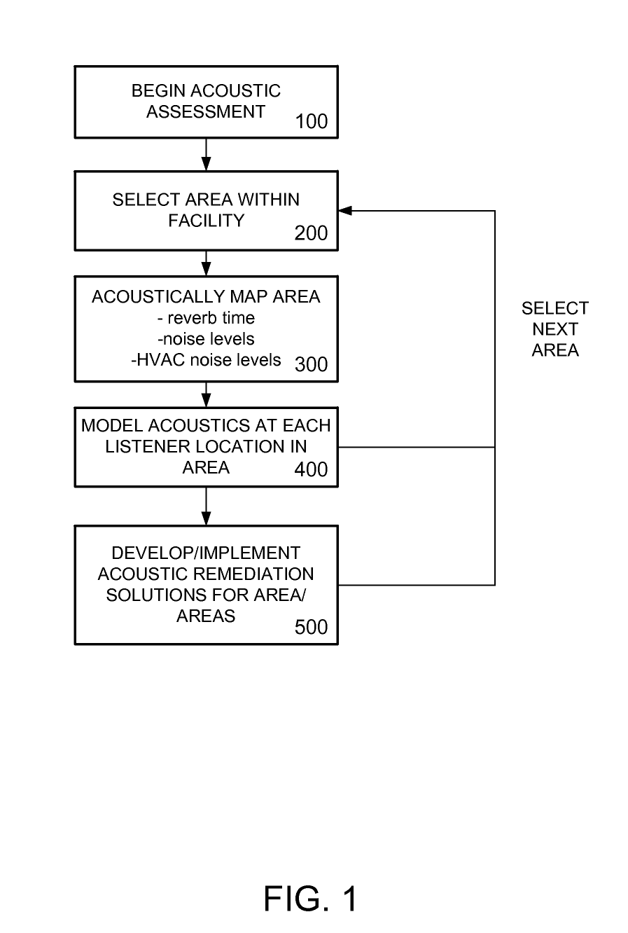

### DETAILED DESCRIPTION OF EXEMPLARY EMBODIMENTS

Over 66% of people over the age of 70 experience hearing loss, and this number increases with age (e.g., 75% of people over the age of 75). Hearing aids and similar devices, however, do not function well in senior assisted-living communities or facilities. White noise and background noise are not handled well by these devices, and lead to a reduction in social interaction. The loss of social interaction, and concomitant isolation and loneliness, results in more frequent illness, medical treatment, accidents, hospitalizations, and depression, which can lead to or exacerbate Alzheimer's disease, dementia and an overall failure to thrive.

In various exemplary embodiments, the present system is designed to improve the “acoustic wellness” of various public and private spaces, particularly in assisted-living communities or facilities, although the techniques and processes described below can be used in other areas or facilities, such as facilities or locations providing hospice care, hospice centers, nursing homes, hospitals, and residences. The techniques and process described below may also be used in auditoriums, conference centers, meeting halls, convention centers, hotel meeting rooms, and other locations.

In one exemplary embodiment, the present invention comprises an acoustic assessment of the common or public areas in the assisted-living community or facility. These areas include, but are not limited to, dining rooms, theatres, game rooms, and activity or multi-purpose rooms where lectures, sermons, presentations, movies, meetings, entertainment, performances and the like are conducted for individuals or groups. The entire space is acoustically mapped, with measurements of reverb time and noise level with different weightings at each table or listener location within the space. The process also measures HVAC noise, particularly white noise and air handler rumble. These measurements are done with senior-specific method, practices and priorities. Ordinary, conventional acoustic measurements are not optimized for the hard of hearing, with or without hearing aids, or those with dementia.

A computer program models the acoustics at each table or listener location in the space, and identifies speech intelligibility/reverb/decay/amplitude with and without occupants. The program then develops acoustic remediation solutions. These include, but are not limited to, modifications to the HVAC system to reduce white noise and air handler rumble, including modifications to mounts, ductwork baffles and air velocity. Remediation solutions also include sound-absorbing panels engineered to reduce white noise, which are then built and installed where necessary.

In yet another embodiment, the present invention comprises an assessment of sound reinforcement of lectures, presentations, parties, meetings, and the like. The loss of hearing in one or both ears, especially when compounded by Alzheimer's disease or dementia, diminishes or destroys the “Cocktail Party Effect” (i.e., the ability of a person to discern what another is saying when multiple people are speaking at once), which is essential for conversation in group or crowded settings. Special signal processing and electro-acoustic modifications are used to promote limbic engagement, such as broad dispersion loudspeakers where the dispersion is not modulated by frequency and the amplitude is not modulated by the impedance.

In several embodiments, broad dispersion loudspeakers are spaced so that there are no gaps in coverage, particularly in the vocal range between 300 and 4000 Hz. Conventional wisdom includes a midrange that when measured on axis crosses over to a tweeter between 2000 and 2500 Hz. However, any non-linearity in dispersion and amplitude between 300 and 4000 Hz at any seating position is sub-optimal for the hearing impaired, with or without hearing aids, and for anyone with dementia. These individuals simply cannot discern the voice they are trying to listen to from the background noise, revert, and sounds of others speaking.

In one embodiment, the system uses ceiling speakers with the above characteristics and placement. In another embodiment, the broad dispersion speakers are wall mounted (e.g., a HEAL line array). Every area with a listener is illuminated with all frequencies.

In one embodiments, the speakers comprise Model 15 Reference PipeDreams Line Arrays with 4-inch midrange speakers and 1-inch tweeters. The mid-range speakers handle 125-3500 Hz with no crossover in that range. This design is optimum for a wide room with a low ceiling. Closely-spaced ceiling speakers may be used in rooms with higher ceilings. All installations attach to video, and also may comprise hearing aid loops (as described below).

In yet another embodiment, the present invention comprises one or more hearing aid loops in one or more of the spaces described above (e.g., activity or multi-purpose meeting rooms). These loops comprise an inductively-coupled antenna that broadcasts directly to a “T” coil in modern hearing aids (i.e., without sound waves travelling through the air). Senior-specific signal processing is used to enhance intelligibility and the emotional appreciation of music and sounds. In one embodiment, the signal processing incorporates equalization and a euphonic harmonic circuit. The harmonic enhancement assists those with hearing loss to feel sound and music and “fill in the blanks” in their hearing.

The cochlea is populated with small hairs or cilia, which transmit sound vibrations to nerves that are arrayed along its length and curve. With hearing loss there is usually organic death or disability of these hairs and follicles along portions of the cochlea. Some frequencies are detectable and others are lost or seriously attenuated. By adding and transmitting certain harmonics corresponding to octave jumps in modern music to fundamental frequencies, the ear and brain is able to extrapolate or synthesize missing parts of sounds by sum and difference psychoacoustics. Intelligibility is enhanced, music is more enjoyable, and importantly, the opportunity for limbic (startle) response is enabled. Enhancing or restoring intelligibility is critical to diminishing isolation and loneliness. The present invention restores serum dopamine elevation capability through sound and music and hearing with live or recorded music, and is novel to an ageing population that has lost this experience. While particularly useful to ageing populations, especially in conjunction with cognitive associations, the methods are not limited to those populations.

In yet another embodiment, the system provides senior-specific licensed music content. In one embodiment, this music is selected to avoid references to unhappiness, ageing, and similar topics. Instrumental music is played at meal times so the Cocktail Party Effect is not exacerbated by words in vocal music content.

In yet a further embodiment, acoustic absorbing panels may be installed in individual resident's rooms, with or without loop antennas concealed inside. A small, rechargeable portable loop amplifier with microphone may also be provided to individuals, which can be used at dining room tables, similar areas, or in private rooms. For example, when used in a private room, an internal or external microphone can be used for communication with staff, family or friends. A digital or analog input can provide connection to TV, computer, Wi-Fi, Airplay, or the like.

In one embodiment, the acoustic panels may be printed with fabric that color coordinates with wall colors or room décor, or may be printed with photographs, art, scenes, or other images. They can be configured as tiles. In one example, multiple panels can appear as a view of a beach or mountain landscape from a large window. In another embodiment, the panels may be video panels or a video wall with similar imagery.

Additional descriptive material may be found in the following patents and patent applications, all of which are incorporated herein by specific reference for all purposes:

Enhanced Stimulation of the Limbic Auditory Response (U.S. Ser. No. 13/108,057)

Dynamically Adjusting Spectral Content of an Audio Signal (U.S. Ser. No. 13/076,662)

Dynamically Adjusting Spectral Content of an Audio Signal (U.S. Pat. No. 7,899,192)

Method and Apparatus for Audio Processing (U.S. Ser. No. 12/193,036)

Low Frequency Equalization for Loudspeaker System (U.S. Pat. No. 8,098,849)

Method and Apparatus for Wire Signal Transmission (U.S. Ser. No. 11/901,702)

Speaker System (U.S. Pat. No. 8,144,900)

Earphones and Hearing Aids with Equalization (U.S. Ser. No. 13/398,782)

In order to provide a context for the various computer-implemented aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), network PCs, minicomputers, mainframe computers, embedded systems, distributed computing environments, and the like.

Embodiments of the invention may be implemented in the form of computer-executable instructions, such as program code or program modules, being executed by a computer or computing device. Program code or modules may include programs, objections, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices.

In one embodiment, a computer system comprises multiple client devices in communication with at least one server device through or over a network. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A method for analyzing, modeling and improving the acoustic wellness of a public or private space, comprising the steps of:
selecting an area within a facility;
acoustically mapping the area;
modeling, using a processor or microprocessor connected to a computer memory, acoustics at each listener location in the area; and
developing acoustic remediation solutions for the area based on the modeling.
